(19) United States
(12) Patent Application Publication
(10) Pub. No.: US 2022/0392005 A1
(43) Pub. Date: Dec. 8, 2022

(54) Dynamic Contracts

(71) Applicant: Demian Goldstraj, Miami, FL (US)

(72) Inventor: Demian Goldstraj, Miami, FL (US)

(21) Appl. No.: 17/829,308

(22) Filed: May 31, 2022

Related U.S. Application Data
(63) Continuation-in-part of application No. 16/546,666, filed on Aug. 21, 2019, now abandoned.

(51) Int. Cl. G06Q 50/18

(52) U.S. Cl. CPC G06Q 50/188

(57) ABSTRACT

Certain embodiments of the disclosure can include methods and systems for electronic contracts. The embodiments can include defining and populating the terms of a contract. The embodiments can include identifying the services and/or goods contemplated by the contract. The identification of the services and goods can be determined by the prospective consumers, or the prospective providers, of the goods and services, or both. The creation of the contract, modification of its terms, and additions and deletions of any pertinent information, including the attached parties, can be stored in a blockchain structure. The ultimate viability of a contract can then be determined based on the terms and other pertinent information.

### CROSS REFERENCE TO RELATED APPLICATIONS

The present application claims the benefit of U.S. provisional patent application No. 62/720,417 filed on 21 Aug. 2018, the disclosure of which is incorporated in its entirety herein by reference. This application is a continuation-in-part of U.S. patent application Ser. No. 16/546,666.

### FIELD OF INVENTION

The present disclosure relates to blockchain and software-based contracts, including mass contracts.

### BACKGROUND

Presently, traditional service contracts, even electronic contracts, are between a single consumer and a single provider. No mechanisms currently exist to permit multiple parties to consider and attach to a proposed or established contract. And while some examples of smart contracts exist, current implementations are problematic regarding efficient update of the “smart” terms, inconsistent oversight of the smart terms as well as the overall contract impact when dynamically modifying terms, among many other problems. As a result, smart contracts are not widely adopted or trusted, and certainly not available for a large and potentially fluctuating number of parties to join.

### SUMMARY OF THE INVENTION

Some or all of the above needs and/or problems may be addressed by certain embodiments of the disclosure. Contracts created and managed according to the present disclosure allow for the adaptability and interchangeability of the contracts. The technology disclosed herein can minimize the amount of abuse and unfairness that is possible when unequal parties negotiate and agreement.

Certain embodiments can include methods and systems for electronic contracts. According to one embodiment of the disclosure, there is disclosed a method. The method can include defining the terms of the contract, both dynamically and statically. The method can include identifying the consumers interested in contracting for a good or service. The method can include verifying one or more providers proposing to supply the good/service. The method can include publishing all contract information on an internet-connected blockchain, including all contract modifications. The method can also include determining the viability of the contract, based on its terms.

According to another embodiment of the disclosure, there is disclosed a system. The system can include memory, one or more microprocessors, and other computer components necessary or desirable for an electronic implementation of a mass contract system. The system's microprocessors can execute computer instructions stored on at least one computer memory of the system. The computer instructions can include operability to define the terms of a mass contract. The instructions can be further operable to identify and verify the existence of parties to the contract, such as consumers and providers of the goods and services contemplated by the terms of the contract. The computer-readable instructions can also be operable to provide a record of the contract, and all its pertinent information, to an accessible blockchain structure. The instructions can be further operable to determine an ultimate viability of the contract based, at least in part, on the terms of the contract.

Other embodiments, devices, systems, methods, aspects, and features of the disclosure will become apparent to those skilled in the art from the following detailed description.

### BRIEF DESCRIPTION OF DRAWINGS

The detailed description is set forth with reference to the accompanying drawings, which are not necessarily drawn to scale. The use of same reference numbers in different figures indicate similar or identical terms.

FIG. 1 is a flow diagram of an example method for blockchain contracts, according to an embodiment of the disclosure.

FIG. 2 illustrates a block diagram representing a blockchain contract system, according to an embodiment of the disclosure.

FIG. 3 illustrates a sample smart contract, according to an embodiment of the disclosure.

FIG. 4 illustrates a sample interface for tracking network sensors.

### DETAILED DESCRIPTION OF THE PREFERRED EMBODIMENTS

In order that the present invention may be fully understood and readily put into practical effect, there shall now be described by way of non-limiting examples of preferred embodiments of the present invention, the description being with reference to the accompanying illustrative figures.

Certain embodiments herein relate to blockchain contracts. A blockchain contract, as embodied in the present disclosure, can include electronic technologies that are not available to standard paper contracts. And the blockchain contracts disclosed herein also improve upon and specially customize the technologies for use in electronic contracts. A blockchain contract as disclosed herein can allow dynamic modification of certain terms of the contract. It can allow interested parties to monitor transactions and other updates to the contract, which can help in preventing fraud and theft. It can allow for the insertion of parameters and terms, based on sensor data for example, that affect satisfaction of the contract, such as temperature, humidity, acceleration, light, location, and time. A blockchain contract as disclosed herein can eliminate the need for copies, which sometimes results in inconsistencies, by maintaining a single incorruptible version in a secure, published blockchain structure that can include all revisions, deletions, and additions. It can record quantity and quality of assets contemplated by the contract by, for example, linking physical goods to numbers, bar codes, and other sensor-accessible information.

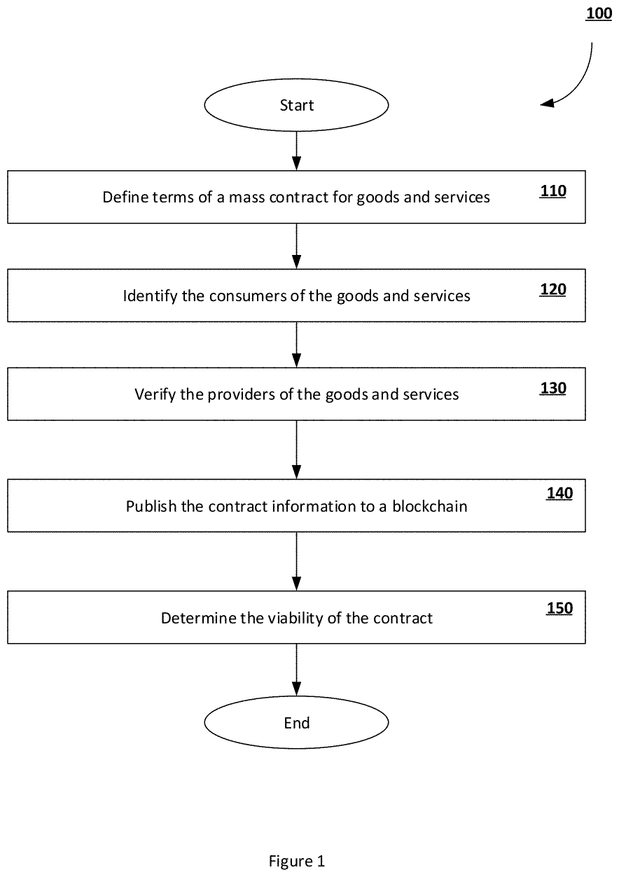

Accordingly, a method can be provided to create, manage, and modify a blockchain contract. For example, FIG. 1 is a flowchart illustrating a process 100 for a blockchain contract, according to various aspects of the present disclosure. The process 100 can begin at block 110. At block 110, process 100 can define the terms of a contract, including of a mass contract, for goods and/or services. Method 100 is not restricted by the type of goods or services, nor by any particular industry or field of endeavor for which the contract is contemplated. Any electronic contract that includes, for example, parties and terms for satisfaction can be represented and maintained by method 100 including, for example, utility contracts between utility companies and residents, transportation contracts between goods manufacturers and consumers, and tourism contracts between airline companies, hotel owners, and travelers, to name just a few examples of possible contracts. Since the terms of the blockchain contract disclosed herein can be dynamic, the establishing of a blockchain contract can be achieved on an ad hoc basis. That is, a potential consumer (or a potential provider, or both) can use computer software running method 100 to create and modify a contract for goods and/or services based on requirements of that consumer (or provider, or both). In this way, method 100 can be used for unique contracts and situations that, in some examples, demand a unique set of contract terms and conditions.

In some embodiments, contract templates can be provided that have already been established via method 100, or that are created specifically for use by method 100. Therefore, method 100 can include both the ad hoc creation, modification, and use of a unique contract; and method 100 can include the provision of commonly used contract templates that can allow for modification, but may not require modifications in all circumstances. A newly proposed contract can be approved for use by method 100 if it is of a preapproved contract form or if it is determined by an artificial intelligence (AI) module to be acceptable.

In some embodiments, the contract can include parameters that are identified by the consumers or providers that are measurable by electronic sensors, and which can update periodically or otherwise based on information detected by the electronic sensors. For example, environmental sensors can be included in a shipment that is managed by method 100. These environmental sensors can detect fluctuations in temperature, humidity, and light exposure, to name just a few measurable factors. These sensor detections can be transmitted, both in real time or periodically, and these transmissions of the sensor data can update the electronic contract terms by publishing the updated conditions measured. In some embodiments, the sensor data can first be transmitted to an intermediate location for storage and/or evaluation, before being transmitted to update the electronic contract on the blockchain. In some embodiments, the sensor data can be evaluated for accuracy or redundancy, or other appropriate reason, to determine the necessity for transmitting the data to the blockchain. In some embodiments, the evaluation of the sensor data can be achieved by an AI module to determine the appropriateness of publishing the new sensor data to the blockchain. In some embodiments, input from a person reviewing the sensor data can be used by method 100 to determine whether the new data is published. In other embodiments, new sensor data can be directly published to the blockchain without utilizing an intermediate review process.

The sensors can be included in the execution of the contract, for example in the transportation of goods, and used specifically for contract parameter conditions and updates. In some embodiments, the sensors can be from among a vast array and network of sensors, such as the internet of things (IoT) which can exist for other purposes beyond contract parameters. The IoT sensors can include communication mechanisms and protocols, or the IoT sensors can utilize outside communications abilities in order to complete the transmission of sensor data to method 100. The selection and utilization of which sensor data to incorporate into method 100 can be predetermined and it can be determined by the parties involved. In some embodiments, the consumers and/or providers of the goods and services can define which contract parameters must be measured to ensure satisfaction of the contract. For example, in a blockchain contract that covers an agreement to ship produce from one location to another, consumers can choose to identify the environmental conditions for parameterization. That is, one or more of the parties, consumers for example, can stipulate that the environmental factors of the produce transportation must be regularly updated via IoT sensors and that sensor data must be published to the blockchain. A parameter of the contract can then be linked electronically to a sensor such that the value shown in the text of the contract reflects the current or most recent measured data from the sensor. These measured values can be published to the blockchain periodically or when the values change. In this way, any person or device with access to the blockchain can see the values measured by the sensors during the life of the contract. These values, fluctuating or not, can then be used in the determination of the viability of the contract, as well as in a determination of whether a breach of contract has occurred. In some embodiments, the number of sensors to include in a contract can be fixed, and the makeup of which sensors can be chosen or agreed upon; while in other embodiments, the number of sensors for a contract can be variable and without restriction. In some embodiments, the sensors used for the contract can be a separate component attachable to other components of method 100. In other embodiments, the sensors can be seamlessly incorporated along with other computer software and hardware components of method 100. In some embodiments, sensors can complement other components. For example, in a transportation contract and scenario, cargo can be within range of sensors, and the sensors can be connected to actuators, message queuing telemetry, and networking devices such as BLUETOOTH- or Wi-Fi-compatible. These components can then (or simultaneously) be connected with AI in order to efficiently manage the components and the resulting data. Throughout this process, the system can be evaluated for authorization, configuration, certification, fail parameters, and trigger inspections. Based on self-governing criteria and programmed conditions, the measured or determined parameter values can then actuate motors and report the conditions depending on the demands of the situation. In one embodiment, a predefined contract such as a bill of lading can include terms that have been agreed upon by all the parties. This contract can be a “smart” contract in that it can contain terms that are updated dynamically based on real-time data throughout the effectiveness of the contract. If the goals of the contract are achieved within the parameters agreed upon and measured dynamically, then the transaction can come to successful completion. If one or more parameters are measured outside acceptable ranges for the applicable period, then an inspection can be triggered. If the triggering conditions are accepted, by AI or operator input for example, then the transaction can still come to a successful completion. Alternatively, out-of-range parameters or non-acceptance of out-of-range parameters can automatically result in a canceling of the contract. These intermediate measurements, evaluations, and steps can be reported to the blockchain, whether the contract is successfully completed or not.

At block 120, method 100 can identify the consumers of the goods and services. Persons interested in receiving the goods or services described in the smart contract can sign onto the contract electronically. Method 100 can require identifying information, such as birth date, mailing address, social security number, cryptocurrency address, or credit card information, to name just a few. Method 100 can verify an identity and assign an available block for the contract to that identity. In some embodiments, method 100 can require an identity to be unique, while in other embodiments, a single identity can be allocated multiple blocks of a single contract. An accepted signature or identity associated with a consumer party of the contract can be discrete, transferable, and tokenizable. In some embodiments, an established place on the contract can be associated with a value, such as the value of the goods or services to be provided, for example. Other factors affecting the value of the transferable block, or token, can include the supply and demand of the provided goods and services, and the value can fluctuate over time. A consumer can choose to divest herself of one or more of her verified blocks in order to monetize the block, for example.

In some embodiments, prospective consumers can sign onto a contract that is initially created by providers of the goods and services. The providers can allow for the negotiation of terms and the providers can fix the terms of the contract. In a single contract, some terms can be fixed by the contract creators, such as the providers, and other terms can be negotiated or variable. In some embodiments, a contract can be created by method 100 and used as a template or basis for the agreement between the consumers and providers, where some are the terms are negotiable and some terms are fixed in the template. In some embodiments, consumers can create a contract and the providers can sign onto the consumer-created contract, with or without including negotiable terms. At block 130, the provider(s) of the goods and services can be verified by method 100. In some embodiments, a provider can be verified by an employer identification number, a provider account setup in the system, and any of the methods utilized for identifying consumers, among other ways.

At block 140, contract information can be published to a blockchain structure. The blockchain structure can include features for publication. In some embodiments, the blockchain can be publicly accessible via an electronic device and an internet connection. A person such as a prospective or established consumer, and a prospective or established provider, as well as an automated service, can access the published information. The structure of the blockchain can include an accessible record of each transaction and modification of the contract. The blockchain can preserve every modification by recording the modified value of the term that changed, and also storing and maintaining the prior values, conditions, parties, and other information that have been part of or are associated with the contract since contract conception. Although a contract term can be changed, the change itself is recorded on the blockchain, along with the previous and current values and the parties associated with the change. In some embodiments, the blockchain can be encrypted, hiding its information to persons or devices that do not possess the decryption key. This can be used, for example, to protect the privacy of the contract and of the parties associated with the contract.

At block 150, the viability of the contract can be determined by method 100. In some embodiments, the software mechanisms of method 100 can evaluate the terms, parties, and other aspects of the contract and make a determination that the contract is viable, not viable, or requires further review. For example, if the verification step for providers fails, then method 100 can determine the contract is not viable in some embodiments. In some embodiments, contract viability can be determined by an AI module. The AI module can, for example, be preprogrammed with and/or have access to special algorithms or immense data sets which the AI can use to predict events based on the current information about the contract. The evaluation made by the AI can then relied upon solely by method 100, or the evaluation can be used in concert with other evaluations available to method 100. In some embodiments, method 100 can receive input from a person regarding a determination of the viability of the contract. Method 100 can then use this input, solely or along with other data, to determine the viability of the contract. For example, a licensed attorney trained in contract law can evaluate the terms of the contract, and provide a professional opinion on the validity and viability of the contract.

The operations described and shown in method 100 of FIG. 1 can be carried out or performed in any suitable order as desired in various embodiments of the disclosure, and method 100 can repeat any number of times. For example, in some embodiments, contract information can be published to a blockchain even before consumers are identified for the goods and services. Additionally, in certain embodiments, at least a portion of the operations can be carried out in parallel. Furthermore, in certain embodiments, fewer or more operations than described in FIG. 1 can be performed.

Method 100 can optionally end after block 150.

According to another embodiment of the disclosure, there is provided a system. For example, system 200 can be provided for smart contract creation and management. System 200 can include computer and electronic hardware and software necessary or desirable for electronic contracts. In some embodiments, all the components of system 200 can reside in a single electronic device.

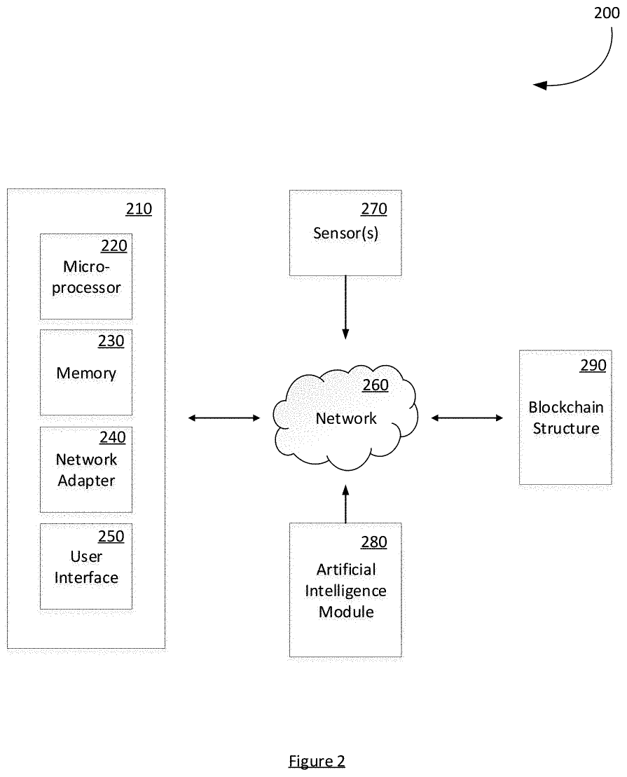

FIG. 2 depicts an example block diagram representing one system for electronic contracts. System 200 can include one or more computer devices 210 that houses some or all of the system components. In some embodiments, components can reside on all separate devices, and in other embodiments, the components can reside on a single device. System 200 can include one or more microprocessors 220 which can reside on a single or on multiple devices 210. System 200 can include computer memory 230 directly connected to the microprocessors 220 or otherwise accessible by microprocessors 220. Memory 230 can be centrally located or distributed throughout a large area accessible by a computer network 260 via one or more network adapters 240. Microprocessors 220 are operable to access memory 230 and execute computer-readable instructions to define and modify the terms of an electronic contract. The terms, modifications, and other contract information can be stored in memory 230. In some embodiments, memory 230 can include a blockchain structure 290. The blockchain 290 can store, encrypt, and make accessible any and all data and information stored within it. Every transaction is discrete and recorded, both in memory 230 and on the blockchain 290. Adding and removing a party from the contract, modifying a contract term, and changing a property of the contract are all examples of transactions that are stored on and accessible from the blockchain 290.

System 200 can identify consumers and prospective consumers of the contract goods and services by a unique identifier or by a value exchange, among other methods. In some embodiments, the contract can be between a single consumer and a single provider. In other embodiments, system 200 can support the participation of a large number of participants, both consumers and providers. In one embodiment, system 200 can support an electronic contract for a sporting event located in Miami, for example. The contract can include a ticket to the sporting event. One or many ticket sellers can join the contract to sell tickets according to the contract terms. The tickets can be of variable value depending on seat location, for example, and any single provider can supply many differing ticket offers. Hotel room providers in the Miami area can also join the contract to provide a room for the dates applicable to the sporting event. Hotel providers can provide variable room packages from which a consumer can choose. Airlines with service to and/or from Miami can participate in the contract. These example providers, as well as any number of other service or goods providers can participate in the contract in order to, for example, reach the consumers of this contract. In some embodiments, providers can package their services and goods together in order to make the package more attractive to consumers. Similarly, multiple providers can package separate goods and services together to offer packages that are more attractive or accessible than the separately available goods and services. In one example of this collaboration among providers, a consumer can have the option of a single discounted purchase price for an entire experience, such as a trip to Miami that includes attendance at the sporting event.

In some embodiments, one or many consumers can join together in order to participate in a contract for goods and services with one or more providers. Each individual consumer can benefit by the addition of more consumers. For example, providers can be more competitive amongst themselves in the price of goods and services offered if the number of consumers is high. Additional consumers can serve to be a negotiating feature of a contract. Indeed, consumers can create new terms and conditions desired by the consumer or consumers, in addition to being able to propose modifications to existing terms originally created, for example, by providers or by the contract template. Templates can include many contract types, as well as contracts used previously in system 200. Newly proposed contracts can be based on popular contracts previously used, and the terms of the new contract can be changed slightly, substantially, or not at all. In some embodiments, system 200 can include payment services and/or processing (1) for transferring the value of the goods and services from a consumer to a provider, (2) for providing any rebates, discounts, or other exchanges from a provider to a consumer, and (3) for exchanging a tokenized block of the contract to an interested party. The payment service and processing of system 200 can be linked to real-world financial institutions, as well as to purely computer-based financial institutions. In some embodiments, an electronic wallet or automated escrow account can be incorporated into a transaction. The wallet can automatically release funds upon completion of performance of the contract, or upon completion of certain stages of the contract.

The number of consumers and the number of providers participating in a mass contract can fluctuate while the contract terms are being negotiated. The negotiation period of the proposed contract can be of a fixed duration and it can also be based on a minimum, maximum, or other determinative quantity after which system 200 determines the contract is viable and enforceable, or after which system 200 determines the contract is, temporarily or finally, unviable or unenforceable. During the proposal stage of the mass contract, parties can both join and exit participation. At the time of binding contract formation, a party can still leave the contract if that party's participation is transferable. In some embodiments, a party's proposed participation in a contract can be contained in a verifiable block and, upon contract formation, the block can become transferable or tokenizable. At the point of contract formation, a tokenizable block can be associated with a certain value depending on the supply and demand, for example, of the goods and services contemplated by the contract. After contract formation, the value of the tokenizable block can fluctuate depending on many factors, such as value speculation. As one example, a residential time share contract can be tokenized and exchanged at different value rates, depending on the time of year or other fluctuating demand for the subject of the contract goods and services. If the block is designated by system 200 as being tokenizable, then a block owner can exchange the block with a third party, at which point the identification of the consumer (or the verification of the provider) who exchanged the block can then be updated by system 200 in the blockchain 290 for the execution of the contract. The exchange of tokenizable blocks can occur without limit during the applicable periods of transferability for the contract, and can be undertaken by both consumers and providers, if the contract permits. A contract can be designated as tokenizable upon contract template creation, and the tokenization can be variable based on which participants can tokenize their blocks, as well as the timing and conditions under which tokenization is permitted. In some embodiments, system 200 can include the promotion and popularization of contracts or contract terms by interested parties.

Based on the legality of the terms of the contract, and the number of consumers and providers, among other factors evaluated, system 200 can determine the viability of the mass contract. In reaching a determination, system 200 can consider evaluations of the contract by AI 280, as well as input received from individuals or devices that have evaluated, for example, legal aspects of the contract. Parties to a contract, and prospective participants of a contract can be apprised of any and all modifications to the contract by system 200. In some embodiments, system 200 can transmit messages electronically to an individual, group, or central message location, updating the contract based on a new transaction or occurrence. In some embodiments, system 200 can both update the blockchain 290 and send messages to interested participants of a contract event. In some embodiments, system 200 can include a user interface 250 that conveys all or a selected portion of the contract information. Contract participants can determine which contract events to receive messages for, as well as set the periodicity of receiving messages. User interface 250 can serve to convey contract information to an interested party such as consumers, providers, prospective consumers, and prospective providers. The information conveyed can include any events, modifications, or other information associated with the contract. In some embodiments, user interface 250 can be used by an interested party to search for a desired contract. The desired contract can be a contract previously used in system 200, a pending contract still open to enrollment by the interested party or otherwise still accessible through tokenization, for example. The search interface can include variable filtering such as contracts within certain industries, providing a desired service or good, and available to a particular region, among other search criteria. User interface 250 can also aggregate statistics and information about the contract or proposed contract, for example, it can convey the number of consumers signed onto the contract, the number of consumers who have dropped out of the contract, and a price or value change of the goods and services offered, to name just a few. User interface 250 can display contract offers relating to a particular restaurant, for example, or package deals in a particular city during a particular timeframe, as another example.

In some embodiments, providers such as a plumber, electrician, and HVAC specialist, can form a contract to provide comprehensive services together for a package rate. For example, these businesses could offer in a mass contract the provision of their comprehensive services for a consumer in a designated region. In one embodiment, the providers can offer comprehensive service for $100 per month if the number of consumers is below 10,000. If the number of consumers exceed 10,000 then the contract can automatically reduce the price of the service, for example to $90 per month if the number of consumers is between 10,000 and 20,000. Division of the revenue for this contract can be fixed and it can fluctuate depending on, for example, the amount of work of one service provider relative to the amount of work of other service providers. In some embodiments, a manufacturing company, a shipping company, and an insurance company can create a smart contract, for example a bill of lading, that is beneficial to both as well as to consumers in being able to take advantage of the synergy of the companies' experience working together. In some embodiments therein, for example, IoT sensors 270 can be incorporated in the shipping mechanisms for measurement of data during the shipment. These measurement updates can be published to the blockchain 290 to update the smart contract, or dynamic bill of lading. System 200 can identify an industry related to the contract goods and services, and then convey applicable information regarding the industry or a related industry via user interface 250. In some embodiments, system 200 can display advertisements or promotions for other contracts via user interface 250, and based on an identification of an industry or market. In some embodiments, the applicability of advertising and promotions can be based, in part or in whole, on evaluations by AI 280. User interface 250 can also include the ability of putting like-minded parties together. For example, user interface 250 can include a congregating area, such as a chatroom or message board, where parties from a particular region, or parties interested in particular goods and services, can communicate and negotiate.

The negotiation process which can ultimately lead to a binding contract can be automated based on user input, AI 280, and prior contracts. Dynamic consideration of the current and fluctuating terms can result in system 200 rejecting or accepting the same proposed term, based on updated values for other terms. For example, a consumer proposal of $200 for automobile brake service can be rejected by AI 280 if the number of prospective consumers is below a certain number, such as 15. If the number of prospective consumers rises above 15 then a renewed or archived request for the $200 price can be inserted into the price term of the contract. And if the number of prospective consumers falls below 15, for example, one second before that contract is evaluated for viability, then system 200 and AI 280, if necessary, can again reject the lower price term based on fewer than necessary consumers. System 200 is capable of handling very massive contracts, such that 100,000 consumers or more can sign onto a particular contract that involves dozens of providers and thousands of smart contract fields. The scalability and modularity of system 200 establishes no ceiling to the complexity of a single contract or of many affiliated contracts.

System 200 can include sensors 270 associated with a contract. In some embodiments, data received or measured by sensors 270 can be directly associated with contract terms and parameters. For example, a contract for delivering goods subject to spoilage can include terms, parameters, and conditions that measure time and environmental conditions of the goods. The sensor 270 data can automatically populate parameters and terms in the smart contract and can automatically validate or invalidate a contract based on conforming with the requirements of the contract. In some embodiments, the ultimate validity or invalidity of a contract can be determined by system 200 in considering data and information gathered and prepared by sensor 270 data in conjunction with AI 280, as well as human input, such as review by a licensed attorney. The sensors 270 can include sensors existing in and on devices for purposes other than a particular contract, such as sensors 270 embedded as part of IoT. Sensors 270 can also be placed specifically for the purpose of and use by one or more smart contracts.

System 200 can include a legal certification process that reviews a contract at inception, completion, or both. The review can ensure the contract is viable and applicable. Performance of the contract can be certified via blockchain 290. Each contract can be as unique or as common as desired. In some embodiments, whether or not a contract has been breached can be a question of a single contract term. In other embodiments, a breach of contract may be determined by evaluation of many terms, and possibly also including input from a human reviewer of the contract. In some embodiments, consumers and providers can register a criticism or dissatisfaction with contract performance, which might not rise to the level of contract breach. System 200, with or without assistance by AI 280, can evaluate this dissatisfaction to determine if it rises to a level necessary to take further action. Further action can include a determination of breach of contract, compensation to dissatisfied parties, compensation to all parties, or no action. System 200 can report to the blockchain 290 the dissatisfaction, the evaluation, and the outcomes, if any. In embodiments where each step of the dissatisfaction is published, system 200 can permit parties to intervene, for example to avoid contract cancellation, to appease dissatisfied parties.

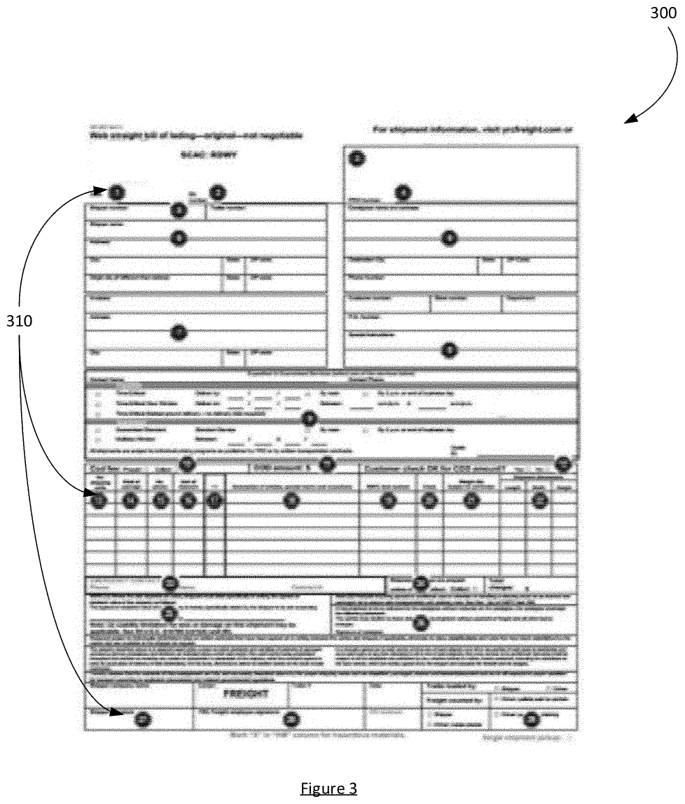

FIG. 3 depicts an example smart contract according to one embodiment of the disclosure. In some embodiments, smart fields 310 can be prepopulated in a contract or template 300, and either fixed in value or modified during the negotiation and execution of the contract. In some embodiments, fields 310 can be empty originally and their values can be entirely dependent on the negotiation process and execution. Contract 300 can be dynamically populated by the fields 310 being linked to one or more computer networks 260, such as the internet, and then linked again to other computers or to sensors 270. Data detected by sensors 270 can directly populate the fields 310, and the data can also be disseminated from raw sensor data into a form appropriate for contract 300.

Each sensor 270 can be uniquely identified and the unique identifier can then be linked to smart contract 300. In some embodiments, sensor data can undergo review and/or modification by, for example, AI 280 or via human input. Sensors 270 can communicate via BLUETOOTH, Wi-Fi, or cellular networks, for example, and can transmit data directly to contract 300 or indirectly via a system 200 review process. In some embodiments, sensors 270 can communicate via MQTT to a broker, such as IBM-BLUMIX, which can then send information to the cloud, to blockchain 290, to contract 300, or to another system 200 device. In some embodiments, the data can be sent to all the above-mentioned locations.

The parameters and conditions that populate fields 310 can be evaluated by AI 280, for example, to measure whether the contract 300 conditions are being met. For example, temperature and humidity can be very critical conditions for a shipment that uses smart contract 300. Regular measurement of the conditions, for example every minute, can be communicated to the blockchain 290 to be accessed by the parties to the contract 300. This can enable a consumer to know if the required conditions are being met, for example for perishable items. This immutable blockchain 290 record of the conditions during the term of the contract 300 can serve as evidence in a conflict for breach of contract. Similarly, a provider can access the blockchain 290 record of sensor 270 readings and make changes to the shipping process before a breach of contract may occur, if unacceptable conditions are caught in time. For conditions that are fluctuating, sometimes meeting requirements and sometimes failing requirements, AI 280 can be called on by system 200 to evaluate whether there is a risk of breach of contract based on the fluctuating conditions. AI 280 can include not only the terms agreed by the parties, but also industry and governmental standards and regulations that are applicable to the contract 300 in question. For example, the FDA has guidelines on specific temperatures needed to transport most edible items and drugs. These guidelines can be embedded electronically into contract 300 and the guidelines can be accessible via network connection 260 by AI 280.

Different shipments can require different sensors 270 or different usage of the same sensors 270. For example, the shipment of pharmaceuticals requires different conditions than a shipment of oranges and apples. AI 280 can take these differences into consideration so that sensor 270 measurement will trigger an alert or breach only if it is appropriate for the given shipment, sensor data, timing, and other factors. In some embodiments, a price associated with the conditioned shipment of goods can be variable, as represented in smart fields 310, based on a constant or fluctuating environment for the shipped goods. Therefore, other fields 310 can be affected by data collected by sensors 270, including fields not directly associated with the particular sensor.

As desired, embodiments of the disclosure may include systems with more or fewer components than are illustrated in the drawings. Additionally, certain components of the systems may be combined in various embodiments of the disclosure. The systems described above are provided by way of example only.

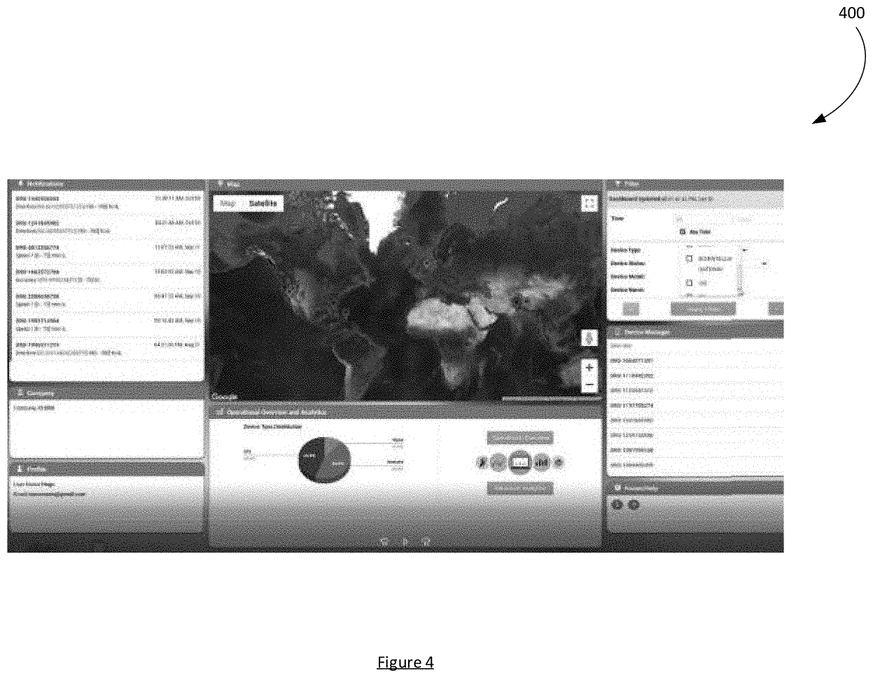

With reference now to FIG. 4, embodiments of the invention include systems and methods implementing sensors, computer networks, and logic for dynamically negotiating terms of an electronic contract. In some embodiments, bills of lading can be included in the electronic contract. In other embodiments, a bill of lading can be the electronic contract. System 200 can include multiple template bills of lading for use in a given situation. A user, or the system itself, can select an appropriate template. From this selected template, terms can be added or disused through customization of the template. A customized template can be stored for later use by the same system, or remotely stored for use by other systems. The terms of a bill of lading can be assigned one or more attributes, including whether a terms is mandatory or otherwise, in order to achieve contract completion. Mandatory terms can include an acceptable value or range of values required to satisfy the successful completion of the contract. Other attributes can represent environmental parameters for terms such as temperature, humidity, and time. Environmental parameters can be important in shipping certain items, and in shipping items long distances. For shipments where environmental terms are designated as prioritized, the completion of a contract can hinge on the data received from environmental sensors regarding the real-time conditions of the shipment.

In some embodiments, for example shipments of perishable food items, environmental sensors can measure the shipment conditions, and be evaluated to determine whether or not a contract was successfully completed. This evaluation can be done automatically, via a pre-programmed acceptable range of, for instance, time values compared with the aggregate sensor readings of the time measured. This information can be received by a contract evaluation process to determine success, failure, or some other result. The real-time network connectivity between the environmental sensors and the electronic contract can dynamically update other terms of the contract. For example, time sensors on a shipment of precious metal, such as gold, can produce varying values of the shipment, depending on the varying price of gold for the duration of the shipment. This variation can affect not only the value of the contract, but also incidental costs, such as shipping insurance.

In embodiments that include sensors for temperature or humidity, for example, sensor measurements outside an acceptable range could automatically cancel a contract. Sensor measurements that vary but are not outside an acceptable range, could dynamically trigger a lower price term, rather than a contract cancellation, for example. This triggering of one term, price for example, can itself trigger an update in the value of another term. In some embodiments, a price term that has updated lower (for any reason) can trigger an update to a required delivery date term, for example. In some scenarios, a shipment may be prioritized for delivery based on the value of the shipment, and an update on the shipment value can push back (or forward) the scheduled delivery of that shipment. Some sensors can trigger actions above just communicating measurements to a remote network. For example, the sensors can trigger cameras to record and transmit images. Sensors can also trigger alarms for the operator of the shipment, as well as communicate to the blockchain that an alarm was triggered.

The sensors can be communicably connected to a network via cellular or other communication technologies, which are located on or near the shipping platform. In some embodiments, an over-the-road shipment can include multiple sensors, any number of which can be environmental. These sensors can communicate to remote computers via a dedicated, or shared, cellular network, for example, located within the environment of the shipment, such as within the trailer of a semi truck. The data can be published to a blockchain at a time interval appropriate for, or designated for, the particular shipment. This publication of real-time variables can make it easier to gain broad acceptance for dynamically negotiated terms of an electronic contract. Verification of the sensors themselves, can be achieved in many commonly used ways, as well as via nonfungible token standards, such as ERC-1150 or ERC-720, for example.

Another benefit of real-time evaluation of contract completion is real-time contract payment. Upon the electronic verification of a completed contract, payment can be transferred via electronic banking, such as a trust wallet, e-payment, or other electronic mechanism. The real-time measurements provided by the sensors and immediately communicated to a blockchain and other users, can be accessible in a centralized “dashboard” application 400. The dashboard 400 can filter a display of sensors according to customized criteria, such as for a single shipment, a single item of a shipment, or groups of items and shipments. An operator of the shipment (e.g. driver, conductor, captain, etc.) can authorize issues when necessary, including by signing electronically.

The features of the present embodiments described herein may be implemented in digital electronic circuitry, and/or in computer hardware, firmware, software, and/or in combinations thereof. Features of the present embodiments may be implemented in a computer program product tangibly embodied in an information carrier, such as a machine-readable storage device, and/or in a propagated signal, for execution by a programmable processor. Embodiments of the present method steps may be performed by a programmable processor executing a program of instructions to perform functions of the described implementations by operating on input data and generating output.

The features of the present embodiments described herein may be implemented in one or more computer programs that are executable on a programmable system including at least one programmable processor coupled to receive data and/or instructions from, and to transmit data and/or instructions to, a data storage system, at least one input device, and at least one output device. A computer program may include a set of instructions that may be used, directly or indirectly, in a computer to perform a certain activity or bring about a certain result. A computer program may be written in any form of programming language, including compiled or interpreted languages, and it may be deployed in any form, including as a stand-alone program or as a module, component, subroutine, or other unit suitable for use in a computing environment.

Suitable processors for the execution of a program of instructions may include, for example, both general and special purpose processors, and/or the sole processor or one of multiple processors of any kind of computer. Generally, a processor may receive instructions and/or data from a read only memory (ROM), or a random access memory (RAM), or both. Such a computer may include a processor for executing instructions and one or more memories for storing instructions and/or data.

Generally, a computer may also include, or be operatively coupled to communicate with, one or more mass storage devices for storing data files. Such devices include magnetic disks, such as internal hard disks and/or removable disks, magneto-optical disks, and/or optical disks. Storage devices suitable for tangibly embodying computer program instructions and/or data may include all forms of non-volatile memory, including for example semiconductor memory devices, such as EPROM, EEPROM, and flash memory devices, magnetic disks such as internal hard disks and removable disks, magneto-optical disks, and CD-ROM and DVD-ROM disks. The processor and the memory may be supplemented by, or incorporated in, one or more ASICs (application-specific integrated circuits).

The features of the present embodiments may be implemented in a computer system that includes a back-end component, such as a data server, and/or that includes a middleware component, such as an application server or an Internet server, and/or that includes a front-end component, such as a client computer having a graphical user interface (GUI) and/or an Internet browser, or any combination of these. The components of the system may be connected by any form or medium of digital data communication, such as a communication network. Examples of communication networks may include, for example, a LAN (local area network), a WAN (wide area network), and/or the computers and networks forming the Internet.

The computer system may include clients and servers. A client and server may be remote from each other and interact through a network, such as those described herein. The relationship of client and server may arise by virtue of computer programs running on the respective computers and having a client-server relationship to each other.

The above description presents the best mode contemplated for carrying out the present embodiments, and of the manner and process of practicing them, in such full, clear, concise, and exact terms as to enable any person skilled in the art to which they pertain to practice these embodiments. The present embodiments are, however, susceptible to modifications and alternate constructions from those discussed above that are fully equivalent. Consequently, the present invention is not limited to the particular embodiments disclosed. On the contrary, the present invention covers all modifications and alternate constructions coming within the spirit and scope of the present disclosure. For example, the steps in the processes described herein need not be performed in the same order as they have been presented, and may be performed in any order(s). Further, steps that have been presented as being performed separately may in alternative embodiments be performed concurrently. Likewise, steps that have been presented as being performed concurrently may in alternative embodiments be performed separately.

What is claimed is:

1. A method for creating a mass contract, the method comprising:
defining, via at least one microprocessor, terms of the mass contract;
identifying, via the at least one microprocessor, at least one consumer of a service;
verifying, via the at least one microprocessor, at least one provider of the service;
configuring, via the at least one microprocessor, customization of the terms of the mass contract, the configuring based at least in part on dynamically negotiated terms;
detecting, via an electronic sensor, information associated with the mass contract;
publishing, via blockchain structure, modifications of the mass contract; and
determining, via the at least one microprocessor, a viability of the mass contract based at least in part on the terms.

2. The method as recited in claim 1, further comprising modifying the terms based on input of the at least one consumer.

3. The method as recited in claim 1, further comprising adding a term to the mass contract based on input of the at least one consumer.

4. The method as recited in claim 1, further comprising modifying the terms based on input of the at least one provider.

5. The method as recited in claim 1, further comprising adding a term to the mass contract based on input of at least one provider.

6. The method as recited in claim 1, wherein determining the viability is based at least in part on input of a legal professional.

7. The method as recited in claim 1, further comprising evaluating the mass contract via an artificial intelligence module.

8. The method as recited in claim 7, wherein determining the viability is based at least in part on the evaluating.

9. The method as recited in claim 1, further comprising modifying the mass contract based at least in part on the sensor information.

10. The method as recited in claim 1, further comprising associating, via the at least one microprocessor, one of the at least one user with a tokenizable block.

11. The method as recited in claim 1, further comprising associating, via the at least one microprocessor, one of the at least one provider with a tokenizable block.

12. A system for mass contracts, the system comprising:
at least one microprocessor;
at least one sensor operable to detect information associated with a mass contract; and
at least one memory storing computer-readable instructions, the at least one microprocessor operable to access the at least one memory and execute the computer-readable instructions to:
define terms of a mass contract;
identify consumers of a service;
verify providers of the service;
configure customization of the terms of the mass contract, the customization based at least in part on dynamically negotiated terms;
publish a record of the mass contract to a blockchain structure; and
determine a viability of the mass contract based at least in part on the terms.

13. The system as recited in claim 12, wherein the computer-readable instructions are further operable to define the terms based in part on input of at least one of the consumers and the providers.

14. The system as recited in claim 12, further comprising an artificial intelligence module.

15. The system as recited in claim 14, wherein the viability is based at least in part on an evaluation of the mass contract by the artificial intelligence module.

16. The system as recited in claim 12, wherein the computer-readable instructions are further operable to tokenize a consumer of the service.

17. The system as recited in claim 12, wherein the computer-readable instructions are further operable to tokenize a provider of the service.
